(19) United States
(12) Patent Application Publication
(10) Pub. No.: US 2013/0054857 A1
(43) Pub. Date: Feb. 28, 2013

(54) REDUCING LATENCY AT A NETWORK INTERFACE CARD

(71) Applicants: Neil R.T Horman, Cary, NC (US); Eric L. Paris, Raleigh, NC (US); Jeffrey T. Layton, Raleigh, NC (US)

(72) Inventors: Neil R.T Horman, Cary, NC (US); Eric L. Paris, Raleigh, NC (US); Jeffrey T. Layton, Raleigh, NC (US)

(21) Appl. No.: 13/218,026

(22) Filed: Aug. 25, 2011

(51) Int. Cl. G06F 13/24

(52) U.S. Cl. 710/260

(57) ABSTRACT

A computing device receives a first data packet at a network interface card. The network interface card asserts a hard interrupt request on a first processing device based on a interrupt affinity value. A latency reduction module consults a data structure to identify a second processing device and schedules a soft interrupt request for the first data packet on the second processing device. The latency reduction module determines if an affinity threshold is met, and if the affinity threshold is met, updates the interrupt affinity value to reflect the second processing device.

### TECHNICAL FIELD

This disclosure relates to the field of network packet handling and, in particular, to reducing latency at a network interface card.

### BACKGROUND

Many conventional operating systems have a “siloed” approach to the handling of network traffic. For example, a frame or data packet may be received by a computing device over a network at a network interface card (NIC). The network interface card asserts a hard interrupt request (IRQ) to a processing device in the computing device. The hard interrupt request is a physical signal sent over a wire to the processing device, indicating that an event has occurred (i.e., a packet was received on the NIC). The processing device to which the hard interrupt request is sent may be selected based on scheduler constraints and optimizations. A soft interrupt request may be scheduled on the same processing device for further processing of the frame. The soft interrupt request may occur at a later time and the additional processing may include, for example, passing the frame through the network stack. In a system with multiple processing devices, in order to minimize the need for high-overhead locking (i.e., explicit mutual exclusion to shared data structures), and prevent the associated latency, some systems only allow one processing device to handle frames from a given source at one time. Thus, in these systems, the soft interrupt request is always scheduled on the same processing device to which the hard interrupt request was sent.

When handling of the packet associated with the soft interrupt request is complete, the packet is enqueued to a receiving socket. An application that owns the socket dequeues the packet and uses the data packet as appropriate, depending on the application. These operations within the application may be performed by the same processing device or a different processing device, depending on the scheduler constraints and optimizations. When the processing of a network packet takes place on one processing device for most of its receive path, and then that consistency is broken by the application, an inefficiency may result. Switching from one processing device to another may lead to cache misses and decreased performance.

### BRIEF DESCRIPTION OF THE DRAWINGS

The present disclosure is illustrated by way of example, and not by way of limitation, in the figures of the accompanying drawings.

FIG. 1 is a block diagram illustrating a computing environment for reducing latency at a network interface card, according to an embodiment.

FIG. 2 is a block diagram illustrating a network packet processing flow for reducing latency at a network interface card, according to an embodiment.

FIG. 3 is a block diagram illustrating a latency reduction module, according to an embodiment.

FIG. 4 is block diagram illustrating an interrupt request data structure, according to an embodiment.

FIG. 5 is a flow diagram illustrating a method for reducing latency at a network interface card, according to an embodiment.

FIG. 6 is a block diagram illustrating one embodiment of a computer system, according to an embodiment.

### DETAILED DESCRIPTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Embodiments are described for reducing latency at a network interface card. A computing device receives a first data packet at a network interface card. The network interface card asserts a hard interrupt request on a first processing device based on a interrupt affinity value. A latency reduction module consults a data structure to identify a second processing device and schedules a soft interrupt request for the first data packet on the second processing device. The data structure includes multiple entries corresponding to previously received data packets, and each of the multiple entries includes source and destination values and an application to which the corresponding data packet was directed. Identifying the second processing device includes identifying one of the multiple entries where the source and destination values of the entry match the source and destination values of the received first data packet. The latency reduction module determines if an affinity threshold is met and, if the affinity threshold is met, updates the interrupt affinity value to reflect the second processing device. The affinity threshold may be a configurable value that specifies, for example, that the IRQ affinity should be examined and updated after every received packet, after a certain number of packets have been received, after a certain period of time has expired, after a certain percentage of packets require rescheduling of the soft interrupt request, or some other value. Thus, for subsequently received data packets, the hard interrupt request is asserted on the second processing device based on the updated affinity value.

The latency reduction techniques described herein seek to optimize the latency between the time a data packet is received by the network interface card and the time the data contained in that packet is available to the receiving application for use. Adjusting the interrupt affinity so that both the hard and soft interrupts, as well as the application specific processing of a data packet are all performed by the same processing device, can improve the efficiency of the packet processing. Not having to reschedule some processing functions on different processing devices can prevent cache misses and other decreases in performance.

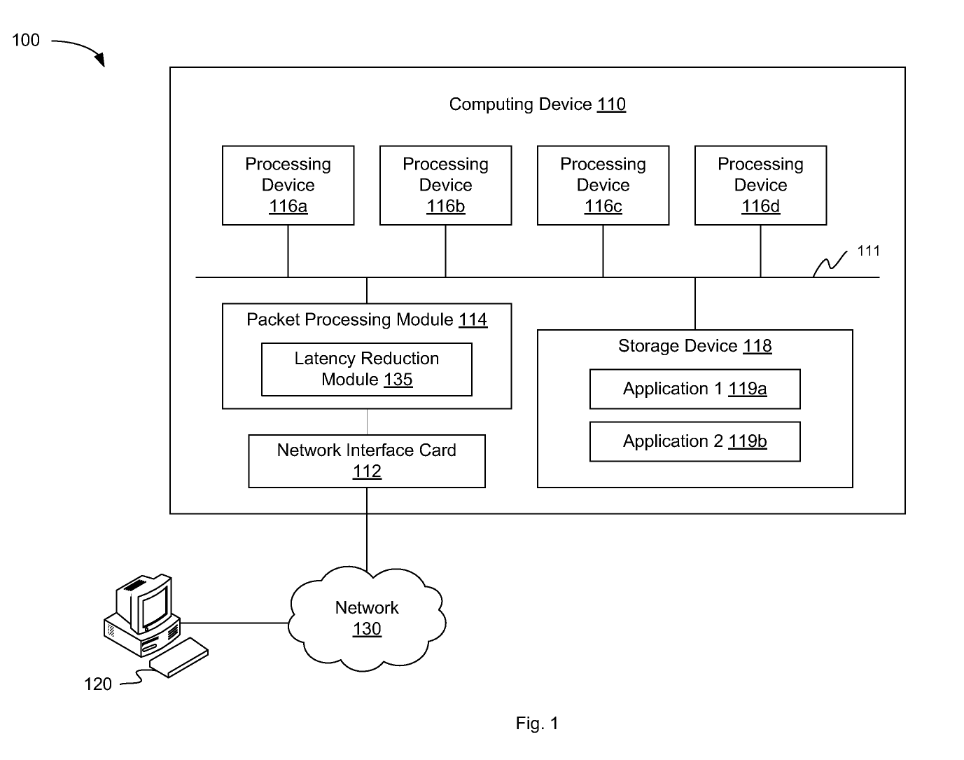

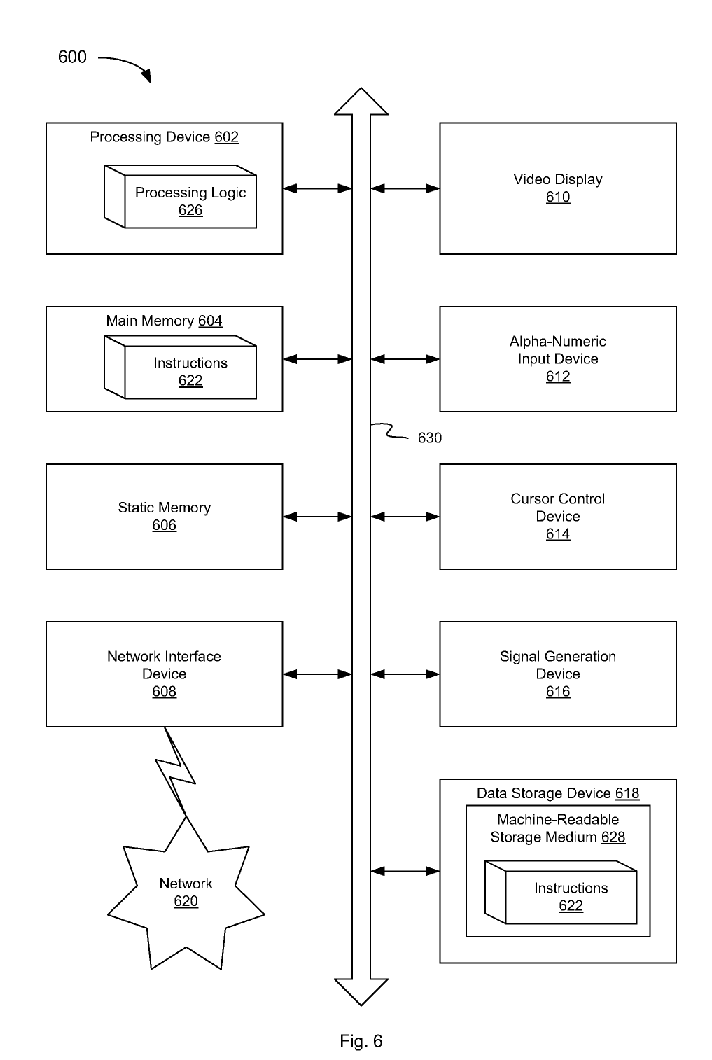

FIG. 1 is a block diagram illustrating a computing environment for reducing latency at a network interface card, according to an embodiment of the present invention. In one embodiment, network environment 100 includes computing device 110 and one or more network devices 120. Computing device 110 may include, for example, computer system 600 of FIG. 6. Network device 120 may be any other device connected to computing device 110 through network 130. Network device 120, may be for example, another computing device, a client device, a server device, a user device, or some other device. Network 130 may be any type of data network configured to connect multiple computing devices, such as for example, a local area network (LAN), a wide area network (WAN), a global area network (GAN) such as the Internet, or a combination of such networks. In another embodiment, network device 120 may have a direct connection to computing device 110 and any other devices in the computing environment 100. The illustrated embodiment shows one computing device 110 and one network device 120, however, in other embodiments, there may be any number of computing devices 110 or network devices 120, and environment 100 may include additional and/or different devices.

In one embodiment, computing device 110 may include network interface card 112, packet processing module 114, one or more processing devices 116a-116d, and storage device 118. These various components of computing device 110 may be connected together via bus 111. Bus 111 may be a common system bus, including one or more different buses, or may be one or more single signal lines between individual system components.

In one embodiment, network traffic may be received by computing device 110 over network 130 from network device 120. The network traffic may include a series of data frames or packets which are received at network interface card 112. Network interface card (NIC) 112 may be a computer hardware component including electronic circuitry to communicate using a specific physical layer and data link layer standard such as Ethernet, Wi-Fi, etc. The network interface card 112 may be the base of a network protocol stack, allowing communication among computing devices through routable protocols, such as Internet Protocol (IP). Upon receiving a data packet, network interface card 112 may assert a hard interrupt request to one of processing devices 116a-116d. In one embodiment, computing device 110 is a multiprocessor device containing two or more processing devices. The hard interrupt request may be a physical signal sent over a wire (or bus 111) to a processing device 116a, indicating that an event has occurred (i.e., a packet was received on the NIC 112). The processing device 116a may be selected according to an interrupt affinity value, which is initially based on scheduler constraints and optimizations. The interrupt affinity causes all interrupt requests sent by network interface card 112 to be sent to processing device 116a. The interrupt affinity value may be stored, for example, in a register or other data structure in storage device 118.

In response to the hard interrupt request, packet processing module 114 may schedule a soft interrupt request to be asserted in the near future. In one embodiment, the soft interrupt request may be scheduled on the same processing device 116a on which the hard interrupt request was asserted. The soft interrupt request may schedule additional processing, such as passing the received data packet through the network protocol stack. The soft interrupt request may be scheduled on and executed by the same processing device 116a as the hard interrupt request in order to avoid the need for explicit locking. Processing the data packet may include a number of accesses to various data structures, and in a multiprocessor system, where processing of multiple data packets may occur in parallel, it is desirable to avoid conflicting look ups from different processing devices. Explicit locking (i.e., mutual exclusive access to the shared data structures) can use excessive overhead and can result in a latency in processing the data packets. Causing the hard and soft interrupt requests to be executed on the same processing device eliminates the conflicts and thus the need for explicit locking.

Once the packet processing associated with the soft interrupt request is complete, an application, such as one of applications 119a-119b takes over processing of the data packet. The applications 119a-119b may be stored, for example, in storage device 118. Storage device 118 may include one or more mass storage devices which can include, for example, flash memory, magnetic or optical disks, or tape drives, read-only memory (ROM); random-access memory (RAM); erasable programmable memory (e.g., EPROM and EEPROM); flash memory; or any other type of storage medium. An application 119a may be executing on a different processing device (e.g., processing device 116b) than where the hard and soft interrupt requests were scheduled. This may require a transfer of the processing of the data packet from one processing device 116a to another processing device 116b. This transfer in the middle of the packet processing may lead to inefficiencies, such as cache misses and decreased performance.

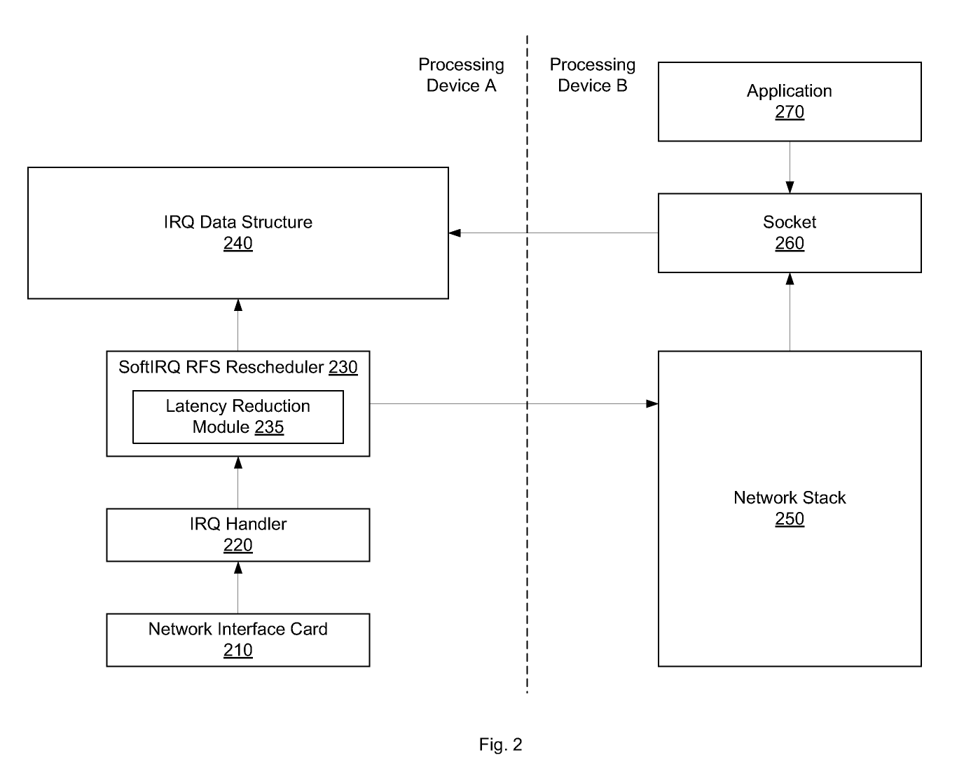

In one embodiment, packet processing module 114 may include latency reduction module 135. Latency reduction module 135 may implement a method, as described below, to reduce the latencies present in conventional packet processing techniques. As will be described in further detail below with respect to FIGS. 2-5, latency reduction module 135 may identify an application to which a received data packet is addressed and the processing device on which that application is executing. Latency reduction module 135 can then update the interrupt affinity so that future hard and soft interrupt requests will be asserted on the same processing device on which the application is executing. This may eliminate the need for a transfer to another processing device in many cases and improve the overall performance of the packet processing.

FIG. 2 is a block diagram illustrating network packet processing flow for reducing latency at a network interface card, according to an embodiment of the present invention. The various modules and components may be described in regards to their roles in processing a received network packet or packets. In one embodiment, network interface card 210 receives a network packet from a network, such as network 130 of FIG. 1. Upon receiving the packet, network interface card 210 may generate a hard interrupt request sent to a designated processing device based on its current interrupt affinity. For purposes of explanation the designated processing device is referred to a processing device A. Processing device A, may include, for example, processing device 116a of FIG. 1.

In one embodiment, IRQ handler 220 may handle the hard interrupt request. IRQ handler 220 may include kernel code run by the processing device (e.g., processing device A) for the specific interrupt request. IRQ handler 220 may also schedule a soft interrupt request to perform additional processing at a later time.

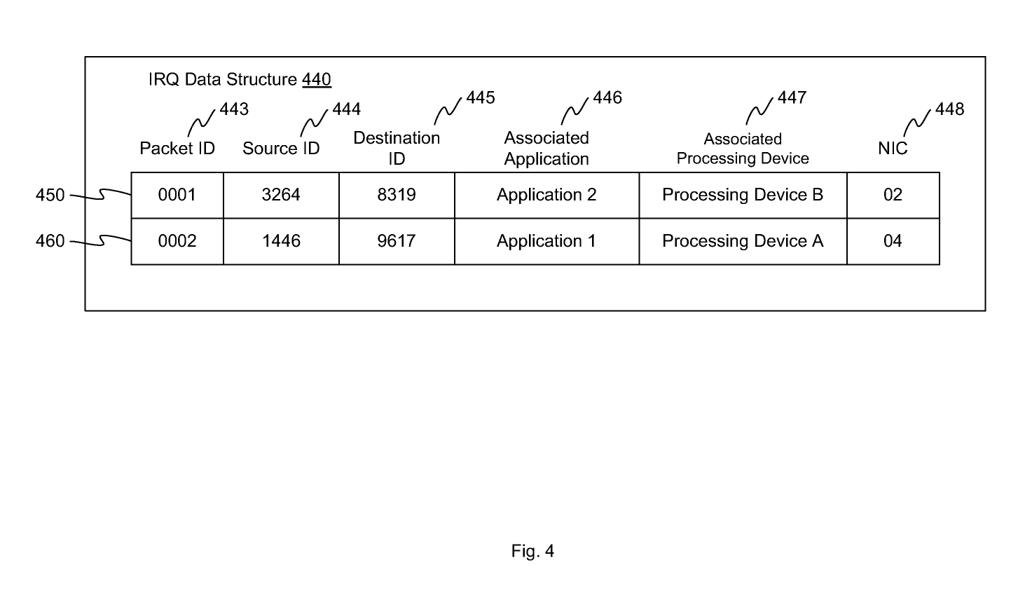

In response to the assertion of the hard interrupt request, latency reduction module 235, in SoftIRQ RFS Rescheduler 230, may consult an interrupt request (IRQ) data structure 240 to identify an application and processing device to which the received network packet is directed. For each received data packet, SoftIRQ RFS Rescheduler 230 may use Receive Flow Steering (RFS) technology to create and/or view an entry in IRQ data structure 240. As described below with respect to FIG. 4, in one embodiment, each entry in IRQ data structure 240 may include information about the source and destination of the associated network packet, as well as the application 270 to which the packet is directed and the processing device on which the application 270 is currently executing. In one embodiment, IRQ data structure 240 may be implemented in the form of a hash table, however in other embodiments, any other suitable data structure may be used. Over time, as IRQ data structure 240 increases in size, newly received network packets can be compared to the entries in IRQ data structure 240 to identify other packets that had the same source and destination values. It is likely that packets having the same source and destination will be directed to the same application 270. Based on the application, latency reduction module 235 can determine which processing device in the computing device will handle processing of the network packet. In one embodiment, this may be a different processing device (e.g., processing device B, which may be one example of processing device 116b of FIG. 1). In one embodiment, the processing device which will handle processing of the network packet is determined from IRQ data structure 240. There may be a processing device identified in the data structure for packets having a certain combination of course and destination values. The processing device identifier may be updated periodically as a network packet is delivered to a particular application executing on a certain processing device.

Once latency reduction module 235 determines the processing device associated with the destination application, SoftIRQ RFS Rescheduler 230 can reschedule the soft interrupt request (originally scheduled on processing device A by IRQ handler 220) on that processing device (e.g., processing device B), whereby the network packet will be passed through network stack 250 to socket 260. Socket 260 is the means by which an application, such as application 270, interacts with network stack 250. application 270 may read data from or write data to socket 260. Network stack 250 processes data, such as a network packet, to deliver it to its destination. Application 270 can retrieve the network packet from socket 260 for additional application specific processing.

In one embodiment, latency reduction module 235 can determine if an IRQ affinity threshold has been met. The IRQ affinity threshold is the level at which latency reduction module 235 will update the IRQ affinity of network interface card 210. The IRQ affinity threshold may be configurable and may be set for every received packet, after a certain number of packets have been received, for a certain period of time, for a certain percentage of packets that require rescheduling of the soft interrupt request, or for some other value. If latency reduction module 235 determines that the IRQ affinity threshold has been met, latency reduction module 235 may update the IRQ affinity value to reflect the processing device B, on which the most recent network packet was processed, a majority of network packets are processed, etc. The IRQ affinity may be stored in a register or other data structure in storage device 118 of FIG. 1. Updating the IRQ affinity will cause a hard interrupt request to be scheduled on processing device B for future network packets received at network interface card 210. This results in the hard and soft IRQs being asserted on the same processing device (e.g., processing device B), leading to processing efficiencies.

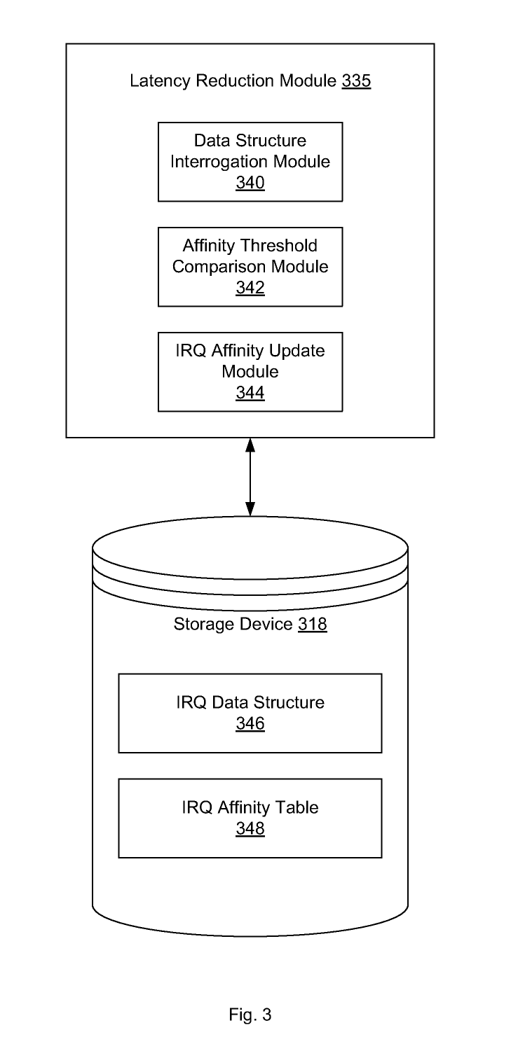

FIG. 3 is a block diagram illustrating a latency reduction module, according to an embodiment of the present invention. In one embodiment, latency reduction module 335 runs on SoftIRQ RFS Rescheduler 230, as shown in FIG. 2. In one embodiment, latency reduction module 335 includes data structure interrogation module 340, affinity threshold comparison module 342 and IRQ affinity update module 344. Latency reduction module 335 may be coupled to storage device 318, which includes IRQ Data Structure 346 and IRQ affinity table 348. In one embodiment, storage device 318 may be representative of storage device 118, as discussed above with respect to FIG. 1.

Latency reduction module 335 can optimize the latency between a time a packet is received by a network interface card and the time the data contained in that packet is available to a receiving application for use. In one embodiment, upon receiving the data packet at the network interface card 210 and asserting the hard interrupt request to the current processing device (e.g., processing device A) based on the IRQ affinity, data structure interrogation module 340 interrogates (or reads) IRQ data structure 346. Data structure interrogation module 340 may compare a source and destination values of the received data packet to the source and destination values of each entry in IRQ data structure 346. Data structure interrogation module 340 may identify other entries having the same combination of source and destination values and read the corresponding application and processing device values for those entries. If the processing device associated with the matching entry is different from the processing device on which the hard interrupt request was asserted for the received data packet, data structure interrogation module 340 may notify SoftIRQ RFS Rescheduler 230 and instruct it to schedule a soft interrupt request on the processing device (e.g., processing device B) identified in IRQ data structure 346.

Upon scheduling of the soft interrupt request, affinity threshold comparison module 342 determines whether an affinity threshold has been met. The affinity threshold may be a configurable value, set for example, by a user, system administrator, to a default value, or some other value and may take a number of different forms. The affinity threshold may specify, for example, that the IRQ affinity should be examined and updated after every received packet, after a certain number of packets have been received, after a certain period of time has expired, after a certain percentage of packets require rescheduling of the soft interrupt request, or some other value.

In one embodiment, where the affinity threshold indicates that the IRQ affinity should be examined and updated after every received packet, the IRQ affinity is updated to reflect the processing device on which the soft interrupt request for the previous received packet was scheduled. IRQ affinity update module 344 may write a value identifying the processing device (e.g., processing device B) to an entry in IRQ affinity table 348 corresponding to the network interface card 210. This processing device may have been determined from IRQ data structure 346 by data structure interrogation module 340 as described above. The result is that the next data packet received on network interface card 210 will have a hard interrupt request asserted on the same processing device. This process would then repeat for each received data packet.

In another embodiment, the value identifying Processing Device B may be written directly to the interrupt controller, such as IRQ handler 220. The interrupt controller may be, for example, an input/output advanced programmable interrupt controller (I/O APIC) or 8259 interrupt controller, configured to be programmed with a processing device identifier and assert future interrupts on that processing device. This identifier may be determined from IRQ data structure 346.

In another embodiment, where the affinity threshold indicates that the IRQ affinity should be examined and updated after a certain number of packets have been received, a counter (not shown) may count the number of packets received at network interface card 210. Once affinity threshold comparison module 342 determines that the number reaches a predetermined count value (e.g., 10 data packets), IRQ affinity update module 344 may update the affinity value in IRQ affinity table 348 to reflect the processing device associated with the last received data packet.

In another embodiment, where the affinity threshold indicates that the IRQ affinity should be examined and updated after a certain period of time has expired, a timer (not shown) may count down from or up to a predetermined value. Once affinity threshold comparison module 342 determines that the timer reaches the predetermined value (e.g., one second), IRQ affinity update module 344 may update the affinity value in IRQ affinity table 348 to reflect the processing device associated with the last received data packet.

In another embodiment, where the affinity threshold indicates that the IRQ affinity should be examined and updated after a certain percentage of packets require rescheduling of the soft interrupt request, affinity threshold comparison module 342 keeps track of the processing device associated with the application to which a past certain number of packets (e.g., the last 10 packets) were directed. If a certain percentage of those packets (e.g., 50%) have the same processing device that is different from the current processing device affinity, IRQ affinity update module 344 may update the affinity value in IRQ affinity table 348 to reflect the most common processing device associated with the data packets.

FIG. 4 is block diagram illustrating an interrupt request data structure, according to an embodiment. IRQ data structure 440 may be representative of IRQ data structure 240 shown in FIG. 2 or IRQ data structure 346 shown in FIG. 3 and may be a table, a database, a file, etc. IRQ data structure 440 may include a number of entries 450, 460, where each entry corresponds to a different data packet received at a network interface card 210. In one embodiment, each entry 450, 460 may contain a number of fields, including Packet ID 443, Source ID 444, Destination ID 445, Associated Application 446, Associated Processing Device 447, and NIC 448.

Packet ID field 443 may store a value representing an identifier of the data packet with which the entry 450 is associated. The value in packet ID field 443 may be any unique value that can be used to identify the data packet. Source ID field 444 may store a value representing the source from which the data packet was sent. The value in source ID field 444 may represent, a network device, such as network device 120 as shown in FIG. 1. Destination ID field 445 may store a value representing the destination to which the data packet was directed. The value in destination ID field 445, may represent for example, a port address or a socket address, associated with socket 260, for example.

Associated application field 446 may store a value representing the application to which the data packet associated with the entry 450 was directed. In one embodiment, the value in associated application field 446 may be the name of the application (e.g., Application 2). A packet may be directed to a particular application when it is intended to be used or processed by that application. For example, an HTTP packet may be directed to a web browser application. The application may be linked to the combination of the values in the source ID field 444 and destination ID field 445, such that latency reduction module 335 can determine that future data packets having the same combination of source and destination are intended for the same application. Associated processing device field 447 may sore a value representing the processing device on which the associated application is executing. In one embodiment, the value in associated processing device field 447 may be the name of the processing device or some other identifier (e.g., Processing Device B). Latency reduction module 335 can read this value and instruct SoftIRQ RFS Rescheduler 230 to schedule the soft interrupt request on that processing device and update the IRQ affinity for the network interface card accordingly, if necessary. Network Interface Card (NIC) field 448 may include an identifier of the NIC on which the network packet associated with the entry was received. This identifier may be used to update IRQ routing information for that NIC.

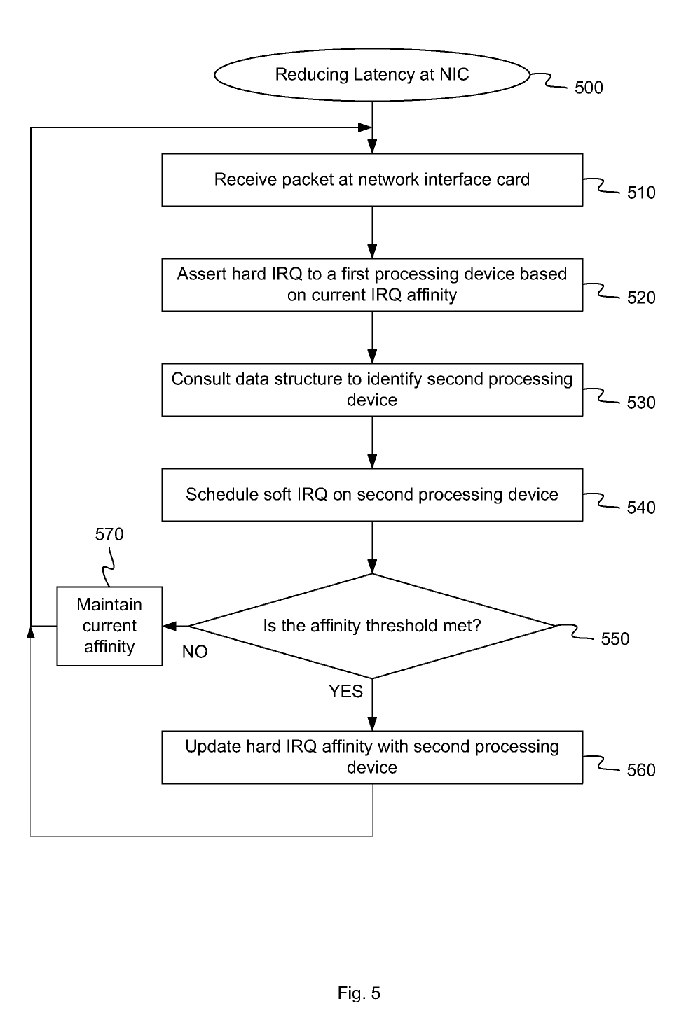

FIG. 5 is a flow diagram illustrating a method for reducing latency at a network interface card, according to an embodiment of the present invention. The method 500 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to identify an associated processing device and update an interrupt request affinity value so that all processing of a received data packet is performed on the same processing device. In one embodiment, method 500 may be performed by latency reduction module 135, 235, 335 as shown in FIGS. 1-3.

Referring to FIG. 5, at block 510, method 500 receives a data packet at a network interface card, such as network interface card 210. The data packet may be received over a network 130 from some other network device 120. The data packet may be any packet containing data, such as for example, an Internet Protocol (IP) packet. At block 520, method 500 asserts a hard interrupt request to a first processing device based on a current IRQ affinity. The IRQ affinity may designate one processing device 116 to handle hard interrupt requests for the network interface card 210. The IRQ affinity may be stored, for example, in IRQ affinity table 348.

At block 530, method 500 may consult a data structure to identify a second processing device, to which the received data packet is directed. Data structure interrogation module 340 of latency reduction module 335 may consult IRQ data structure 346 to determine the second processing device. The second processing device may be a processing device which is currently running an application associated with previous data packets that share the same combination of source and destination as the data packet received at block 510. Data structure interrogation module 340 may compare the combination of source and destination values for the received packet with the source and destination values of each previously received network packet that has an entry in IRQ data structure 346. At block 540, method 500 schedules a soft interrupt request on the second processing device. Data structure interrogation module 340 may send a message to SoftIRQ RFS Rescheduler 230 instructing it to schedule the soft IRQ on the second processing device. In one embodiment, the second processing device may be a different processing device than the first processing device.

At block 550, method 500 determines if the IRQ affinity threshold has been met. Affinity threshold comparison module 342 of latency reduction module 335 may make this determination. The affinity threshold may be a configurable value that specifies, for example, that the IRQ affinity should be examined and updated after every received packet, after a certain number of packets have been received, after a certain period of time has expired, after a certain percentage of packets require rescheduling of the soft interrupt request, or some other value.

If at block 550, method 500 determines that one of the threshold conditions is met, at block 560, method 500 updates the IRQ affinity value with the second processing device. IRQ affinity update module 344 may overwrite a current value stored in IRQ affinity table 348 that is associated with network interface card 210. As a result, a hard interrupt for any subsequently received data packet will be asserted on the second processing device according to the IRQ affinity. If at block 550, method 500 determines that the affinity threshold is not met, at block 570, method 500 maintains the current IRQ affinity (i.e., the first processing device) and returns to block 510 to wait for a next data packet to be received.

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 600 may be representative of a computing device, such as computing device 110, running latency reduction module 135.

The exemplary computer system 600 includes a processing device 602, a main memory 604 (e.g., read-only memory (ROM), flash memory, dynamic random access memory (DRAM) (such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute processing logic 626 for performing the operations and steps discussed herein.

The computer system 600 may further include a network interface device 608. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

The data storage device 618 may include a machine-accessible storage medium 628, on which is stored one or more set of instructions 622 (e.g., software) embodying any one or more of the methodologies of functions described herein. The instructions 622 may also reside, completely or at least partially, within the main memory 604 and/or within the processing device 602 during execution thereof by the computer system 600; the main memory 604 and the processing device 602 also constituting machine-accessible storage media. The instructions 622 may further be transmitted or received over a network 620 via the network interface device 608.

The machine-readable storage medium 628 may also be used to store instructions to perform a method for reducing latency at a network interface card, as described herein. While the machine-readable storage medium 628 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

What is claimed is:

1. A method, comprising:
asserting a hard interrupt request on a first processing device based on an interrupt affinity value;
consulting a data structure to identify a second processing device;
scheduling a soft interrupt request for a first data packet on the second processing device, the first data packet received at a network interface card;
determining if an affinity threshold is met; and
if the affinity threshold is met, updating the interrupt affinity value to reflect the second processing device.

2. The method of claim 1, wherein the second processing device is associated with an application to which the received first data packet is directed.

3. The method of claim 1, wherein the data structure comprises a plurality of entries corresponding to previously received data packets, and wherein each of the plurality of entries comprises source and destination values and an application to which the corresponding data packet was directed.

4. The method of claim 3, wherein identifying the second processing device comprises identifying one of the plurality of entries where the source and destination values of the entry match source and destination values of the received first data packet.

5. The method of claim 1, wherein the affinity threshold specifies that the interrupt affinity value is to be examined and updated after at least one of every received packet, a certain number of packets have been received, a certain period of time has expired, and a certain percentage of packets require rescheduling of the soft interrupt request.

6. The method of claim 1, further comprising:
receiving a second data packet at the network interface card; and
asserting a hard interrupt request on the second processing device based on the interrupt affinity value.

7. The method of claim 1, further comprising:
if the affinity threshold is not met, maintaining a current interrupt affinity value.

8. A system comprising:
a processing device; and
a memory coupled to the processing device; and
a latency reduction module, executed by the processing device from the memory, to:
assert a hard interrupt request on a first processing device based on an interrupt affinity value;
consult a data structure to identify a second processing device;
schedule a soft interrupt request for a first data packet on the second processing device, the first data packet received at a network interface card;
determine if an affinity threshold is met; and
if the affinity threshold is met, update the interrupt affinity value to reflect the second processing device.

9. The system of claim 8, wherein the second processing device is associated with an application to which the received first data packet is directed.

10. The system of claim 8, wherein the data structure comprises a plurality of entries corresponding to previously received data packets, and wherein each of the plurality of entries comprises source and destination values and an application to which the corresponding data packet was directed.

11. The system of claim 10, wherein identifying the second processing device comprises identifying one of the plurality of entries where the source and destination values of the entry match source and destination values of the received first data packet.

12. The system of claim 8, wherein the affinity threshold specifies that the interrupt affinity value is to be examined and updated after at least one of every received packet, a certain number of packets have been received, a certain period of time has expired, and a certain percentage of packets require rescheduling of the soft interrupt request.

13. The system of claim 8, the latency reduction module further to:
receive a second data packet at the network interface card; and
assert a hard interrupt request on the second processing device based on the interrupt affinity value.

14. The system of claim 8, the latency reduction module further to:
if the affinity threshold is not met, maintain a current interrupt affinity value.

15. A non-transitory machine-readable storage medium storing instructions which, when executed, cause a data processing system to perform a method comprising:
asserting a hard interrupt request on a first processing device based on an interrupt affinity value;
consulting a data structure to identify a second processing device;
scheduling a soft interrupt request for a first data packet on the second processing device, the first data packet received at a network interface card;
determining if an affinity threshold is met; and
if the affinity threshold is met, updating the interrupt affinity value to reflect the second processing device.

16. The non-transitory machine-readable storage medium of claim 15, wherein the second processing device is associated with an application to which the received first data packet is directed.

17. The non-transitory machine-readable storage medium of claim 15, wherein the data structure comprises a plurality of entries corresponding to previously received data packets, and wherein each of the plurality of entries comprises source and destination values and an application to which the corresponding data packet was directed.

18. The non-transitory machine-readable storage medium of claim 17, wherein identifying the second processing device comprises identifying one of the plurality of entries where the source and destination values of the entry match source and destination values of the received first data packet.

19. The non-transitory machine-readable storage medium of claim 15, wherein the affinity threshold specifies that the interrupt affinity value is to be examined and updated after at least one of every received packet, a certain number of packets have been received, a certain period of time has expired, and a certain percentage of packets require rescheduling of the soft interrupt request.

20. The non-transitory machine-readable storage medium of claim 15, the method further comprising:
receiving a second data packet at the network interface card; and
asserting a hard interrupt request on the second processing device based on the interrupt affinity value.

21. The non-transitory machine-readable storage medium of claim 15, the method further comprising:
if the affinity threshold is not met, maintaining a current interrupt affinity value.
